(19) United States
(12) Patent Application Publication
(10) Pub. No.: US 2021/0404115 A1
(43) Pub. Date: Dec. 30, 2021

(54) MAN-MADE LEATHER HAVING EXCELLENT AIR PERMEABILITY AND MANUFACTURING METHOD THEREOF

(71) Applicant: Jeongsan International Co., Ltd., Busan (KR)

(72) Inventors: Bae Sung Cho, Busan (KR); Tae Hyoung Lee, Busan (KR); Min Jae Jeong, Busan (KR)

(21) Appl. No.: 16/476,250

(22) PCT Filed: Jun. 7, 2019
(86) PCT No.: PCT/KR2019/006888

§ 371 Date: Jul. 5, 2019

(30) Foreign Application Priority Data
Aug. 13, 2018 (KR) 10-2018-0094229

(51) Int. Cl. D06N 3/00; D06N 3/14

(52) U.S. Cl. CPC D06N 3/0043; D06N 3/14; D06N 2211/28; D06N 3/0097; D06N 2209/123; D06N 3/0061

(57) ABSTRACT

The present invention relates to a man-made leather having excellent air permeability and manufacturing method thereof, and more particularly, to a man-made leather having excellent air permeability capable of maintaining a permeability by urethane-coating only on a cotton portion of base fabric (20) formed with holes and capable of pattern transfer on release paper, and manufacturing method thereof.

According to the man-made leather having excellent air permeability and manufacturing method thereof, the air permeability can be maintained on the man-made leather by urethane-coating only on a cotton portion of base fabric (20) formed with holes while maintaining the luxury of fabric texture per se and toughness.

### CROSS-REFERENCE TO RELATED APPLICATIONS

This application is the National Phase of PCT International Application No. PCT/KR2019/006888, filed on Jun. 7, 2019, which claims priority under 35 U.S.C. 119(a) to Patent Application No. 10-2018-0094229, filed in the Republic of Korea on Aug. 13, 2018, all of which are hereby expressly incorporated by reference into the present application.

### STATEMENT RE: FEDERALLY SPONSORED RESEARCH/DEVELOPMENT

Not Applicable

### TECHNICAL FIELD

The present invention relates to a man-made leather having excellent air permeability and manufacturing method thereof, and more particularly, to a man-made leather having excellent air permeability capable of maintaining a permeability and capable of pattern transfer on release paper by urethane-coating only on a cotton portion of base fabric formed with holes, and manufacturing method thereof.

### BACKGROUND ART

The man-made leather is synthetic leather so processed as to have excellent physical properties of polyurethane, texture and tactility similar to those of natural leather by using cotton, poly fabric and the like, and reasonable in price and natural in external appearance and texture similar to natural leather for various uses in footwear, interior material, upholstery, clothing, car embedding material, furniture and fashion accessories.

The artificial leather can protect products from external environments, provide functionality catering to particular purposes and realize harmonious colors by coating polyurethane resin on a front surface of cotton, base fabric and the like to form a skin.

The prior art of Korean Registered Patent No.: 10-0349890 entitled a manufacturing process of a polyurethane artificial leather discloses a process for preparing the titled artificial leather by knife-coating an binder polyurethane mixture liquid (II) with a thin skin along the irregularities of a specified pattern of release paper, adhering fabrics to the release paper and drying is provided, thereby polyurethane artificial leather having external appearance and texture similar to natural leather is obtained, where the titled artificial leather is produced by the procedures of: an binder polyurethane mixed liquid is knife-coated with a thin skin along the irregularities of a specified pattern of release paper; fabrics comprising nonwoven fabrics, fabrics and knitting are laminated to release paper, dried with hot blast in a chamber for a specified time and aged; and then fabrics are removed from the release paper.

However, when a front surface is coated with polyurethane, hole(d) portions of poly fabric are blocked by the coating to be deprived of permeability, whereby a luxurious three-dimensional feeling possessed by the fabric disappears. Furthermore, due to coated front surface, the original color and pattern possessed by the poly fabric are disadvantageously cloaked to limit the colors and pattern expressions of the artificial leather products.

Furthermore, the prior art of Korean Laid-Open Patent No.: 2013-0128855 provides a method of manufacturing a fabric having a moire pattern, which is not limited by foam fabric material while having excellent durability, by manufacturing a grid film through coating a resin on the raw fabric in which a releasing property is applied, and forming the moire pattern on the raw fabric through attaching the foam fabric, then laminating it. The technical constitution of the method comprises the steps of: manufacturing a releasing fabric in which a releasing property of yarn tissue is applied; manufacturing a grid film by coating a coating agent on the surface of the releasing fabric; coating an binder on the surface of the grid film; attaching the foam fabric on the surface of the grid film which is coated with the binder; laminating the grid film which is attached with the foam fabric; removing the releasing fabric from the grid film; and forming the moire pattern on the grid film. [Reference numerals] (S10) Step for manufacturing a releasing fabric; (S20) Step for manufacturing a grid film by coating a coating agent on the surface of the releasing fabric; (S21) Step for coating a coating agent comprising polyurethane resin or acrylic resin; (S30) Step for coating an binder on the surface of the grid film; (S40) Step for attaching the foam fabric on the surface of the grid film; (S50) Step for laminating the grid film; (S51) Step for forming the moire pattern by the weft/warp yarn weaving pattern of the releasing fabric and the weft/warp density difference in the foam fabric; (S60) Step for removing the releasing fabric from the grid film; (S70) Step for forming the moire pattern on the grid film. However, the prior art of Korean Laid-Open Patent No.: 2013-0128855 also suffers from disadvantages in that the coated surface of fabric is blocked to result in lack of air permeability.

Therefore, there has surfaced a need to develop a technology configured to coat only a cotton portion of holed fabrics in order to maintain air permeability and to simultaneously enable a pattern transfer on release paper.

### Technical Problem

Therefore, it is an object of the present invention to provide man-made leather configured to maintain excellent air permeability by performing a urethane-coating only on a cotton portion of holed base fabric, and to maintain a luxury and toughness of fabric texture itself, and a manufacturing method thereof.

It is another object of the present invention to provide man-made leather configured to generate a special color effect unachievable from base fabric using a conventional method while solving the low durability of base fabric itself and to perform a pattern transfer of release paper, and a manufacturing method thereof.

### Technical Solution

In one general aspect of the present invention, there is provided a manufacturing method of man-made leather configured to maintain excellent air permeability and to realize pattern effect, the method comprising:

manufacturing a compound coating fluid mixed with skin forming fluid and binder (A);

semi-drying and semi-hardening the compound coating fluid after coating the coating fluid on a first release paper (10) (B);

performing an initial lamination to allow a surface of base fabric (20) to abut with the first release paper (10) having passed the (B) step through the compound coating fluid (C);

performing a second lamination by secondarily laminating a second patterned release paper (30) to a surface of base fabric (20) after separating the first release paper (10) from the base fabric (20) (D); and

separating and delaminating the base fabric (20) from the second release paper (30) (E).

Preferably, but not necessarily, the base fabric (20) may be formed with a plurality of holes.

Preferably, but not necessarily, the (D) step may include that the compound coating fluid remains on a surface of the base fabric (20) after the release paper and the base fabric (20) are separated.

Preferably, but not necessarily, the compound coating fluid may be formed by mixing a skin-forming fluid with binder.

Preferably, but not necessarily, the compound coating fluid may include polyurethane synthetic resin, hardener, methyl ethyl ketone and dimethylformamide.

Preferably, but not necessarily, the surface of the first release paper (10) may be free from patterns (pattern-less).

Preferably, but not necessarily, the (C) step may include a first lamination where the base fabric (20) disposed on an upper surface of the first release paper (10) descends and is compressed by being abutted with the compound coating fluid.

Preferably, but not necessarily, the man-made leather having excellent permeability and realized with pattern effect may be manufactured by the said manufacturing method.

Preferably, but not necessarily, the man-made leather having excellent permeability may be manufactured by being coated on a surface of base fabric (20) with a plurality of holes with the compound coating fluid in which a skin-forming fluid and binder are mixed.

Preferably, but not necessarily, the compound coating fluid may include polyurethane synthetic resin, hardener, methyl ethyl ketone and dimethylformamide.

Preferably, but not necessarily, the compound coating fluid may include 100% parts by weight of polyurethane synthetic resin, 5-10 parts by weight of hardener, 0-10 parts by weight of methyl ethyl ketone and 0-10 parts by weight of dimethylformamide.

### Advantageous Effects

According to the man-made leather having excellent air permeability and method thereof, a tough man-made leather can be manufactured with the air permeability being maintained by performing a urethane-coating only on a surface of base fabric (20) formed with holes while maintaining luxury of texture of base fabric (20) itself.

Furthermore, the man-made leather having excellent air permeability according to the present invention can solve the low durability of base fabric (20) itself and accomplish a special color effect and pattern transfer of release paper that cannot be achieved from the base fabric (20) using the conventional coating method.

### DESCRIPTION OF THE DRAWINGS

FIG. 1 is a process diagram according to an exemplary embodiment of the present invention.

FIG. 2 is a mimetic diagram explaining a process in which urethane coating is performed only on a surface of base fabric (20) formed with holes according to an exemplary embodiment of the present invention.

FIG. 3 is a photograph of base fabric (20) urethane-coated only on a surface of the base fabric (20) formed with holes according to an exemplary embodiment of the present invention.

FIG. 4 is a photograph of a fabric coated by the conventional coating method.

FIG. 5 is specimen photographs of comparative exemplary embodiments 1(a) to 3(c), each made with a different hole shape of a base fabric formed with holes.

### BEST MODE

Hereinafter, exemplary embodiments will now be described more fully with reference to the accompanying drawings, in which exemplary embodiments are shown, wherein like numbers indicate like elements throughout, and descriptions of well-known functions and constructions are omitted for clarity and conciseness. Hereinafter, the suffixes ‘module’, ‘unit’ and ‘part’ may be used for elements in order to facilitate the invention. Significant meanings or roles may not be given to the suffixes themselves and it is understood that the ‘module’, ‘unit’ and ‘part’ may be used together or interchangeably.

In addition, in describing the present invention, if it is determined that the detailed description on the related known technology makes the gist of the present invention unnecessarily ambiguous, the detailed description will be omitted. The description of the present invention has been presented for purposes of illustration and description, but is not intended to be exhaustive or limited to the invention in the form disclosed. Many modifications and variations will be apparent to those of ordinary skill in the art based upon the teachings herein without departing from the scope and spirit of the invention. In some example embodiments, well-known processes, well-known device structures, and well-known technologies are not described in detail.

Furthermore, it should be noted that the accompanying drawings are intended to help easily understand the general characteristics of methods, structure and/or materials utilized in certain example embodiments and to supplement the written description provided below. These drawings should not be interpreted as limiting the range of technical ideas encompassed in the specification, and it should be understood that all changes, equivalents and substitutes within the idea and technical scope of the present invention are included. It is intended that the subject matter disclosed and envisioned herein covers such modifications and variations.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

As used in the specification and in the claims, the singular form of “a”, “an”, and “the” include plural referents unless the context clearly dictates otherwise.

Throughout the specification, it will be further understood that the terms “comprises” and/or “comprising,” when used in this specification, specify the presence of stated features, regions, integers, steps, operations, elements, and/or components, but do not preclude the presence or addition of one or more other features, regions, integers, steps, operations, elements, components, and/or groups thereof.

Hereinafter, exemplary embodiments of the present invention will be described in detail with reference to the accompanying drawings. It will be apparent to those skilled in the art that specific details need not be employed, that example embodiments may be embodied in many different forms and that neither should be construed to limit the scope of the disclosure.

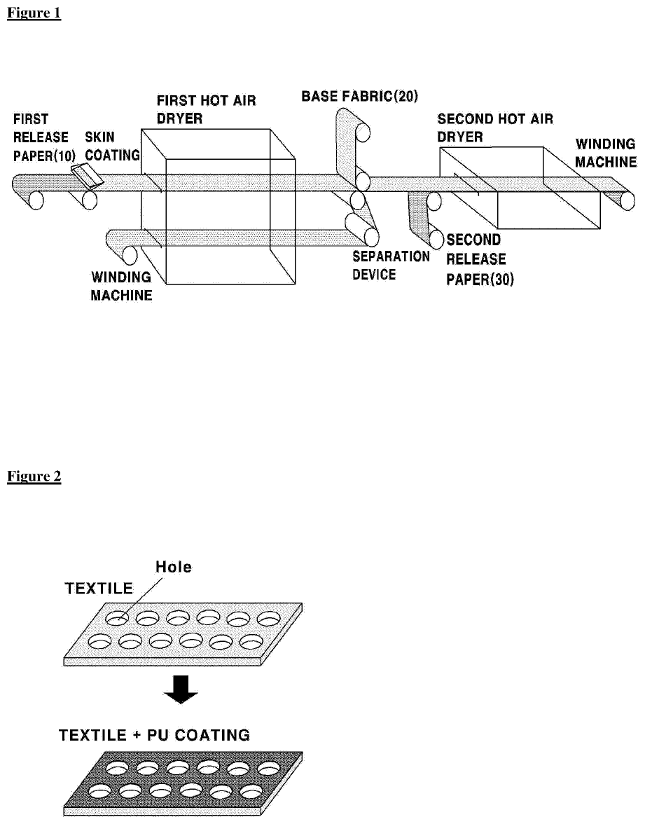

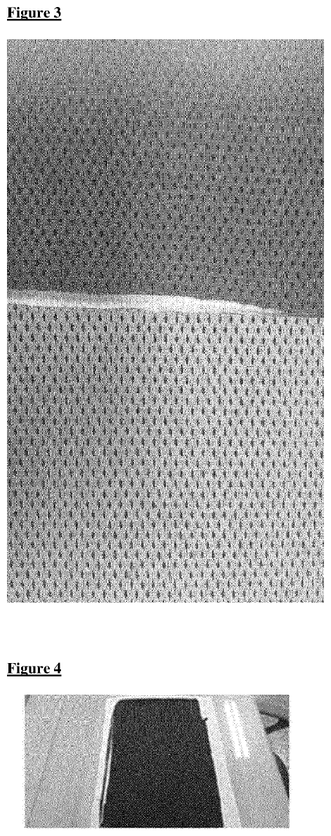

FIG. 1 is a process diagram according to an exemplary embodiment of the present invention, FIG. 2 is a mimetic diagram explaining a process in which urethane coating is performed only on a surface of base fabric (20) formed with holes according to an exemplary embodiment of the present invention, and FIG. 3 is a photograph of base fabric (20) urethane-coated only on a surface of the base fabric (20) formed with holes according to an exemplary embodiment of the present invention.

Referring to FIGS. 1, 2 and 3, the method of manufacturing the man-made leather having excellent air permeability and realizable of pattern effect according to the present invention may comprise:

manufacturing a compound coating fluid mixed with skin forming fluid and binder (A);

semi-drying and semi-hardening the compound coating fluid after coating the coating fluid on a first release paper (10) (B);

performing an initial lamination to allow a surface of base fabric (20) to abut with the first release paper (10) having passed the (B) step through the compound coating fluid (C);

performing a second lamination by secondarily laminating a second patterned release paper (30) to a surface of base fabric (20) after separating the first release paper (10) from the base fabric (20) (D); and

separating and delaminating the base fabric (20) from the second release paper (30) (E).

The compound coating fluid in the above (A) step may be prepared by mixing a skin-forming fluid and binder. Preferably, the compound coating fluid may include polyurethane synthetic resin, hardener, methyl ethyl ketone and dimethylformamide.

The surface of the first release paper (10) in the above (B) and (D) steps may be free from patterns while the second release paper (30) may be formed with patterns.

The base fabric (20) in the above (C) step may include a plurality of holes. At this time, it is preferable that a diameter of the hole be 1 mm-15 mm. Here, when the diameter of the hole is less than a lower limit, the hole may be tightly closed by the coating fluid to degrade the air permeability.

In the above (C) step, compression may be performed in such a manner that the base fabric (20) disposed at an upper surface of the first release paper (10) may descend to abut with the compound coating fluid of the first release paper (10), whereby a first lamination can be realized. As a result, the base fabric (20) formed with holes may downwardly descend from the upper surface of the first release paper (10) to allow being smeared with the compound coating fluid of the first release paper (10), whereby only a cotton portion of the base fabric (20) may be coated and the holes may not be penetrated with the coating fluid.

To this end, the (C) step may include: the said base fabric (20) formed with a plurality of holes disposed at an upper surface and spaced apart from the first release paper (10) having passed the (B) step abutting a pair of rollers by being descended to a direction perpendicular to an advancing direction of the horizontally transferred first release paper (10); and

the said first release paper (10) and the said base fabric (20) simultaneously contacting between and passing through the pair of rollers, and a surface of the said base fabric (20) being pressed to allow abutting the compound coating fluid of the first release paper (10) and being initially laminated.

The (D) step include a step of secondarily laminating the second release paper (30) having patterns on the surface of said base fabric (20) after the first release paper (10) and the base fabric (20) being separated. Here, in the above (D) step, the compound coating fluid remains only on the surface of the base fabric (20) after the first release paper (10) and the base fabric (20) are separated, and the hole remains with no compound coating fluid.

According to the present invention, the conventional skin layer and the binder layer may be simplified to a compound coating layer, and the release paper pattern may be separated into two types, in order to overcome the decreased permeability and limitation in three dimensional feeling caused by coating all surfaces including the skin and binder on the conventional release paper and the hole portions of the base fabric (20).

Furthermore, in order to cope with the problems of degraded air permeability caused by coating the skin and binder on all sides including the hole side of the base fabric (20) in the conventional release paper, the (B) step of the present invention includes semi-drying and semi-hardening by coating the compound coating fluid on the first release paper (10).

Toward this end, the first release paper (10) is coated with the compound coating fluid and then an appropriate temperature of heat is applied to the first release paper (10), dried and hardened. At this time, it is preferable that the Non-Volatile solid content (hereinafter referred to as “NV”) of the compound coating fluid be made to be 20-60 wt %, and the compound coating fluid with the said NV then be coated on the first release paper (10), semi-drying and semi-hardening be implemented to allow the NV of the coated compound coating fluid to be 60-90 wt % by using the temperature and hot wind of initial oven.

Thereafter, the base fabric (20) formed with holes may be made to be positioned at an upper surface of the first release paper (10) to allow descending so that the base fabric (20) to contact the first release paper (10). Subsequently, compression is performed to allow a surface side of base fabric (20) to abut with the compound coating fluid of first release paper (10) on a laminating roller for initial lamination.

And then, the first release paper (10) descends downwards after passing the laminating roller, wound and transferred, where the base fabric (20) passes the laminating roller to be wound to a direction different from the first release paper (10), for example, wound to a horizontal direction, and continuously separated.

In other words, the base fabric (20) formed with holes may be made to downwardly descend from an upper surface of the first release paper (10) to allow the compound coating fluid of the first release paper (10) to be smeared only with a cotton portion of the base fabric (20), whereby the coating is made only on the cotton portion of the base fabric (20) and the holes are not penetrated by the coating fluid. Particularly, the compound coating fluid of the present invention has allow a coated layer to have tacky and sticky characteristic while being in a semi-dried and semi-hardened state, whereby, unlike the completely dried film of solid layer, the hole side of surface at the base fabric (20) during the first lamination is such that the coated layer is not lamination-transferred, whereas only the non-hole side of fabric surface can be selectively lamination-transferred with the semi-dried and semi-hardened coated layer.

Preferably, the no-patterned first release paper (10) may be coated with the compound coating fluid of an amount of 200-300 gr/m², and the release paper coated with the coating fluid may be dried by a temperature-controllable hot air drier (drying chamber condition: 80° C.-130° C., 135-300 seconds).

The base fabric (20) may be preferably a Backer base fabric.

A dry-type coating method may be employed where the patterned second release paper (30) is secondarily laminated with a surface of base fabric (20) separated while the tacky coating fluid is maintained only on a cotton portion of the separated fabric texture, and is made to pass through the same ripening process (80° C., 30 Hrs environment) as that of the conventional drying method, and then, the second release paper (30) is made to be separated and delaminated from a final base fabric.

Through the foregoing processes, the present invention can realize the man-made leather having pattern and color effects that can be generated from the synthetic leather while maintaining the air permeability and the pattern of the second release paper (30) being transferable onto the skin layer.

The present invention can accomplish an excellent effect capable of maintaining the permeability and simultaneously realizing delicate, subtle and natural pattern texture for use in upper materials for shoes, interior materials, car interior materials and furniture materials by realizing a partial coating other than holed portions and by changing/ruling out the conventional coating process method where air permeability and three-dimensional feelings are blocked due to full coating on all surfaces including hole portions of base fabric (20) during manufacturing of dry synthetic leather for use in shoes and the like.

The synthetic man-made leather according to the present invention capable of accomplishing the excellent air permeability and pattern effect can be manufactured by the above manufacturing method.

The excellent man-made leather having an excellent air permeability according to an exemplary embodiment may be characterized by the fact that a surface of base fabric (20) formed with a plurality of holes is coated with compound coating fluid in which a skin forming fluid and binder are mixed.

The man-made leather according to the present invention may be characterized by the compound coating fluid containing polyurethane synthetic resin, hardener, methyl ethyl ketone and dimethylformamide.

The man-made leather according to the present invention may be characterized by the fact that the compound coating fluid contains 100% parts by weight of polyurethane synthetic resin, 5-10 parts by weight of hardener, 0.1-10 parts by weight of methyl ethyl ketone and 0.1-10 parts by weight of dimethylformamide.

The excellent man-made leather having an excellent air permeability according to an exemplary embodiment may comprise:

a release paper layer with patterns;

a skin urethane coating layer showing the patterns by being stacked on the release paper layer; and

a base leather layer.

According to the man-made leather having excellent air permeability and manufacturing method thereof, the air permeability can be maintained on the man-made leather by urethane-coating only on a cotton portion of base fabric (20) formed with holes while maintaining the luxury of fabric texture per se and toughness.

Furthermore, according to the man-made leather having excellent air permeability and manufacturing method thereof, the low durability of base fabric itself can be solved, and special color effect and pattern transfer on release paper used to be unaccomplished by the conventional coating method can be accomplished.

Hereinafter, comparison is made between air permeability according to an exemplary embodiment of the present invention and air permeability of base fabric according to the conventional coating method.

### Exemplary Embodiment

The plain-patterned first release paper (10) was coated with the compound coating fluid (polyurethane synthetic resin 100 parts by weight, hardener 10 parts by weight, methyl ethyl ketone 10 parts by weight, dimethylformamide 10 parts by weight) at a coated amount of 200-300 gr/m², the coating fluid-coated release paper was heated and dried (dry-chamber condition: 80° C.-130° C. for 135-300 seconds) in a temperature-controllable oven, and the hole-existent base fabric (20) was laminated.

Thereafter, compression was applied in such a manner that the coating fluid can be permeated only into the interfaces of the base fabric (20), and the coating fluid-permeated base fabric (20) and the first plain-patterned release paper were separated again. A final (second) lamination was conducted on the surface of the separated base fabric (20) tissue lest detachment be realized on the pattern-added second release paper (30) while the coating fluid was in a tackiness-maintained state. Ageing process was performed under a 80° C., 30 Hrs environment, which is similar to the conventional dry-type coating method, and then a final separation process was implemented.

FIG. 5 is specimen photographs of comparative exemplary embodiments 1(a) to 3(c), each hole-formed base fabric made with a differently-shaped hole.

Hereinafter, base fabrics were made using the conventional coating method from the specimen of comparative exemplary embodiments 1, 2 and 3.

### First Comparative Exemplary Embodiment

Using the conventional technique, a film was manufactured by performing a same process as that of forming a fabric in the Korean Laid-Open Patent No.: 2013-0128855 where resin was coated on a moire pattern fabric, attached with a base fabric and laminated. However, the base fabric was formed with same holes as those of the present invention to allow being laminated.

When the manufacturing process of the first comparative exemplary embodiment is more specifically explained,

(1) A surface of moire patterned base fabric having a particular pattern (grid pattern and the like) was coated and treated with a coating agent, and was passed through a dry chamber, whereby the coating agent-treated moire base fabric was dried.

(2) An binder was evenly coated on the surface of moire patterned base fabric, and the binder was hot-wind treated for preliminary dry.

(3) The hot-wind treated moire patterned base fabric is attached by a fabric formed with holes, and evenly applied with pressure using a laminating (pressure) roller.

(4) Lamination was conducted by allowing the pressure roller-passed moire patterned fabric and the base fabric formed with holes to be passed through the pressure roller again while the pressure roller-passed moire patterned fabric and the base fabric formed with holes were attached.

(5) The laminating roller-passed moire patterned base fabric of attached state and hole-formed base fabric were dried, and then, the moire patterned base fabric was separated.

### Second and Third Comparative Exemplary Embodiments

The shapes of holes on the hole-formed base fabric in the (3) of the first exemplary embodiment were differently made, and other remaining processes were progressed in the same way as in the first exemplary embodiment.

Air permeability was measured on the specimen of exemplary embodiment, and the first to third comparative exemplary embodiments at the FITI Institute of Testing, which is a Korea fabric material testing and evaluation institute.

The air permeability was conducted in line with the method by KS K 0570:2006 (unit: cm³/cm²/s). According to Table 1, the air permeability according to the exemplary embodiment of the present invention was 91, which is a very high air permeability, whereas the air permeability by the first to third comparative exemplary embodiments showed less than 0.1, which proved that almost no air could pass due to tight closeness.

TABLE 1

| | | First | Second | Third |
|---|---|---|---|---|
| | | comparative | comparative | comparative |
| | Exemplary | exemplary | exemplary | exemplary |
| Classification | embodiment | embodiment | embodiment | embodiment |
| Air | 91 | Less than 0.1 | Less than 0.1 | Less than 0.1 |
| permeability | | | | |

(Note)
test area: 38 cm², Pressure difference: 100 Pa

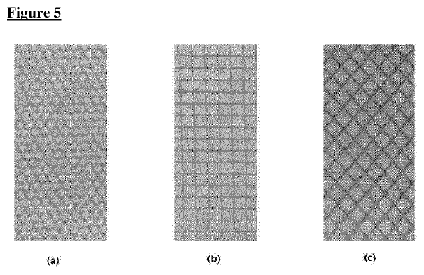

FIG. 4 is a photograph of a fabric coated by the conventional coating method.

Referring to FIG. 4, it was confirmed that not only the cotton of base fabric but also the hole side were tightly closed with coating fluid, which, as is known, is consistent with the measurement result of air permeability.

Meantime, the foregoing detailed descriptions are intended to be exemplary and are not intended as limitations on the scope. It should be understood that the invention as claimed should be determined by rational interpretation of the following claims, and all modifications and other variations within the equivalent scopes are within the scope of the present invention.

What is claimed is:

1. A method of manufacturing the man-made leather having excellent air permeability and realizable of pattern effect according to the present invention comprising:
manufacturing a compound coating fluid mixed with skin forming fluid and binder (A);
semi-drying and semi-hardening the compound coating fluid after coating the coating fluid on a first release paper (10) (B);
performing an initial lamination to allow a surface of base fabric (20) to abut with the first release paper (10) having passed the (B) step through the compound coating fluid (C);
performing a second lamination by secondarily laminating a second patterned release paper (30) to a surface of base fabric (20) after separating the first release paper (10) from the base fabric (20) (D); and
separating and delaminating the base fabric (20) from the second release paper (30) (E).

2. The method of claim 1, wherein the base fabric (20) is formed with a plurality of holes.

3. The method of claim 1, wherein the (D) step includes that the compound coating fluid remains on a surface of the base fabric (20) after the release paper and the base fabric (20) are separated.

4. The method of claim 1, wherein the compound coating fluid is formed by mixing a skin-forming fluid with binder.

5. The method of claim 1, wherein the compound coating fluid includes polyurethane synthetic resin, hardener, methyl ethyl ketone and dimethylformamide.

6. The method of claim 1, wherein the surface of the first release paper (10) is free from patterns (pattern-less).

7. The method of claim 1, wherein the (C) step includes a first lamination where the base fabric (20) disposed on an upper surface of the first release paper (10) descends and is compressed by being abutted with the compound coating fluid.

8. A man-made leather having excellent air permeability manufactured by being coated on a surface of base fabric (20) with a plurality of holes with the compound coating fluid in which a skin-forming fluid and binder are mixed.

9. The man-made leather of claim 8, wherein the compound coating fluid includes polyurethane synthetic resin, hardener, methyl ethyl ketone and dimethylformamide.

10. The man-made leather of claim 8, wherein the compound coating fluid includes 100% parts by weight of polyurethane synthetic resin, 5-10 parts by weight of hardener, 0-10 parts by weight of methyl ethyl ketone and 0-10 parts by weight of dimethylformamide.

11. Man-made leather having excellent air permeability manufactured by the steps of:
manufacturing a compound coating fluid mixed with skin forming fluid and binder (A);
semi-drying and semi-hardening the compound coating fluid by coating the compound coating fluid on a first release paper (10) (B);
performing an initial lamination to allow a surface of base fabric (20) to abut with the first release paper (10) having passed the (B) step (C);
performing a second lamination by secondarily laminating a second patterned release paper (30) to a surface of base fabric (20) after separating the first release paper (10) from the base fabric (20) (D); and
separating and delaminating the base fabric (20) from the second release paper (30) (E).

12. The man-made leather of claim 11, wherein the base fabric (20) is formed with a plurality of holes.

13. The man-made leather of claim 11, wherein the compound coating fluid is mixed with the skin forming fluid and binder.

14. The man-made leather of claim 11, wherein the compound coating fluid includes polyurethane synthetic resin, hardener, methyl ethyl ketone and dimethylformamide.

15. The man-made leather of claim 11, wherein the surface of first release paper (10) is plain-patterned.
